(19) United States
(12) Patent Application Publication
(10) Pub. No.: US 2013/0294794 A1
(43) Pub. Date: Nov. 7, 2013

(54) IMAGE FORMING APPARATUS, OUTPUT ORDER SETTING METHOD, AND COMPUTER PROGRAM PRODUCT

(71) Applicants: Yu YOSHIOKA, Kanagawa (JP); Norikazu Okada, Kanagawa (JP); Tetsuya Yano, Kanagawa (JP)

(72) Inventors: Yu YOSHIOKA, Kanagawa (JP); Norikazu Okada, Kanagawa (JP); Tetsuya Yano, Kanagawa (JP)

(21) Appl. No.: 13/871,569

(22) Filed: Apr. 26, 2013

(30) Foreign Application Priority Data
May 1, 2012 (JP) 2012-104875
Apr. 1, 2013 (JP) 2013-076362

(51) Int. Cl. G03G 15/00

(52) U.S. Cl. CPC G03G 15/2078
USPC 399/82

(57) ABSTRACT

An image forming apparatus includes a heating unit, a storage unit, and a setting unit. The heating unit uses electric power and performs a heating operation in accordance with a print condition specified in a print job to thermally fix a developer onto a recording medium. The storage unit stores therein output priorities, which are determined for different print conditions based on power consumption in a heating operation, so as to be associated with their corresponding print conditions. In outputting a plurality of print jobs having different print conditions successively, the setting unit sets output order of the print jobs to be output in accordance with the output priorities.

### CROSS-REFERENCE TO RELATED APPLICATIONS

The present application claims priority to and incorporates by reference the entire contents of Japanese Patent Application No. 2012-104875 filed in Japan on May 1, 2012 and Japanese Patent Application No. 2013-076362 filed in Japan on Apr. 1, 2013.

### BACKGROUND OF THE INVENTION

1. Field of the Invention

The present invention relates to an image forming apparatus that performs fixing operation for fixing a developer onto a recording medium, an output order setting method, and a computer program product.

2. Description of the Related Art

In image forming apparatuses such as a printer and an MFP that form an image onto a recording medium (hereinafter also referred to as “print paper” or “paper”) based on image data, what is called a laser printer has been widely used as a printer engine. The laser printer performs scanning exposure with a laser beam whose lighting is controlled in accordance with image data processed for output and forms an image using a developer (toner) by means of electrophotography. An image forming process by this method requires high-temperature heating when a toner image formed onto paper is fixed onto the paper, markedly increasing power consumption by a heater for use in this heat-fixing processing.

In recent years, with increased concern toward environments, there have been increasing demands for minimum necessary power consumption in the heat-fixing processing to achieve power saving. As a conventional technique developed to reduce the power consumption in the heat-fixing processing, for example, a technique disclosed in Japanese Patent Application Laid-open No. 2005-164713 is known. Japanese Patent Application Laid-open No. 2005-164713 discloses that, in order to avoid an inefficient operation in which a fixing unit is started up from a waiting state with power saving every time a small number of sheets are printed out, the fixing unit is started up after a predetermined amount of print jobs are accumulated so that there is no need to provide a waiting state between print jobs, thereby improving power usage efficiency. In other words, starting up from the power-saving state is limited to the beginning, and a predetermined amount of print jobs is collectively printed out, thereby reducing heat loss and power consumption.

Because an appropriate fixing temperature in the heat-fixing processing depends on print conditions specified in print jobs including print color (monochrome/color or the like) and paper type (plain paper/or thick paper), a control technique is known in which a target fixing temperature value is set in accordance with print conditions for respective print jobs. By this control technique, however, depending on the print conditions specified in print jobs in a job group waiting for printing that wait for output in the order of print requests (in the order the print jobs are registered), the target fixing temperature may largely and frequently vary between the print jobs in which print output is executed successively. In this case, the temperature rise of a heater is repeated many times, and the heat during the temperature rise period is not effectively used for fixing, lowering power usage efficiency accordingly. Any conventional techniques including Japanese Patent Application Laid-open No. 2005-164713 cannot prevent such a decrease in power usage efficiency when target fixing temperature values are set in accordance with print conditions to perform the heat-fixing processing.

Therefore, there is a need for an image forming apparatus and an output order setting method capable of preventing a decrease in power usage efficiency in the heat-fixing processing and achieving further power saving.

### SUMMARY OF THE INVENTION

According to an embodiment, there is provided an image forming apparatus that includes a heating unit, a storage unit, and a setting unit. The heating unit uses electric power and performs a heating operation in accordance with a print condition specified in a print job to thermally fix a developer onto a recording medium. The storage unit stores therein output priorities, which are determined for different print conditions based on power consumption in a heating operation, so as to be associated with their corresponding print conditions. In outputting a plurality of print jobs having different print conditions successively, the setting unit sets output order of the print jobs to be output in accordance with the output priorities.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of an image forming apparatus according to an embodiment of the present invention;

FIG. 2 is a block diagram illustrating the schematic configuration of a data processing system of the image forming apparatus;

FIG. 3 illustrates graphs showing the relationship of temporal changes in the driving power of a fixing heater for a print job group with respect to time, as compared to Comparative Example;

FIG. 4 illustrates graphs showing the relationship of temporal changes in the driving power of the fixing heater illustrated in FIG. 3 in more detail with respect to time with rise times added;

FIG. 5 is a flowchart illustrating the basic procedure of a print output operation executed in an output order set based on print conditions;

FIG. 6 is a flowchart illustrating the procedure of a print output operation in an output order set based on print conditions including print color, the material of print paper, print paper size, and the type of duplex or single-sided use of the paper;

FIG. 7 is a flowchart illustrating the subroutine of priority setting (1) (Step S202) in FIG. 6;

FIG. 8 is a flowchart illustrating the subroutine of priority setting (2) (Step S203) in FIG. 6; and

FIG. 9 is a diagram illustrating an example of a display screen displaying the processing status of print jobs in an operating unit.

### DETAILED DESCRIPTION OF THE PREFERRED EMBODIMENTS

Hereinafter, an image forming apparatus, an output order setting method, and a computer program according to the present invention will be described with reference to the accompanying drawings. The following embodiment is an example in which the present invention is applied to an electrophotographic image forming apparatus having processing functions of a copier, a printer, or the like integrally that form an image onto print paper with toner as a developer.

The electrophotographic image forming apparatus according to the present embodiment includes a fixing unit that is provided with an electricity-powered heater in order to perform fixing a toner image onto print paper by means of thermal fixing. Because power consumption by the fixing unit occupies a substantial portion of the power consumption of the entire image forming apparatus, it becomes a target of power saving, and in accordance with print conditions specified in jobs (print jobs) that request print output, operations are performed in accordance with operating conditions associated with thermal fixing such as target fixing temperature values, thereby performing fixing operations with minimal power consumption.

Configuration of Image Forming Apparatus

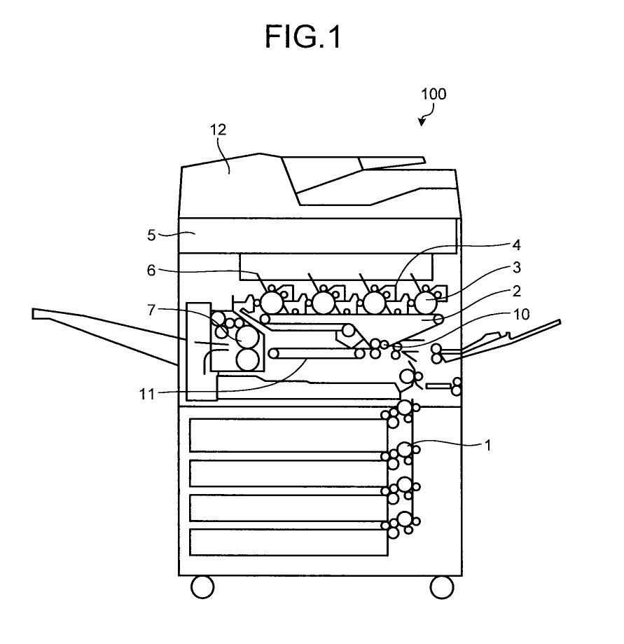

FIG. 1 is a schematic configuration diagram of an image forming apparatus 100 according to the present embodiment. Hereinafter, with reference to FIG. 1, the apparatus configuration, functions, and operations of the image forming apparatus 100 will be described with a focus on operations in a process when the copier's functions are used, including the scanning of a document, generation of print output data from the image data of the scanned document, and image formation onto print paper using the print output data. Operations in a process when the printer's functions are used will be described later supplementarily only for parts different from when the copier's functions are used.

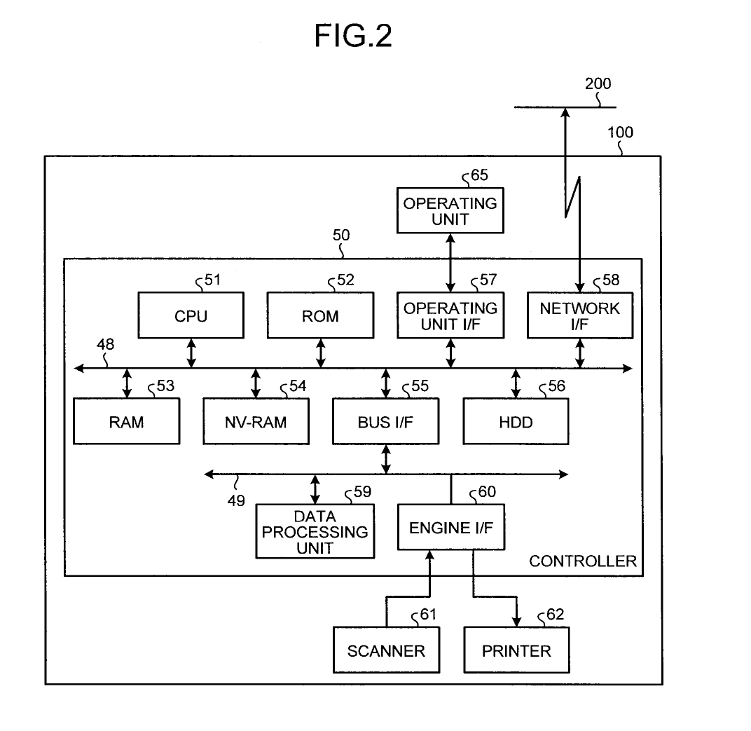

In the image forming apparatus 100 illustrated in FIG. 1, a document placed on a document table of a automatic document feeder 12 is fed to a scanning unit 5 when an operation is started by the pressing of a print key of an operating unit 65 (see FIG. 2 and FIG. 9).

The scanning unit 5 scans a surface of the document with a 3-line charge coupled device (CCD) while illuminating the document by a light source, so as to read an image of the document as signals (data) corresponding to color components. The image data of the document scanned by the scanning unit 5 is subjected to image processing such as scanner gamma correction, color conversion, image separation, and tone correction by a data processing unit of a data processing system (see FIG. 2), which will be described later, and is then sent to an image writing unit 6.

The image writing unit 6 generates print output data from the image data subjected to the image processing by the data processing unit and controls the light emission of a laser diode (LD) using the print output data.

In a photosensitive unit 3, a latent image is written onto a uniformly charged, rotating photosensitive drum with a laser beam from the LD whose light emission is controlled by the image data corresponding to the color components, and toner is allowed to attach thereto by a developing unit 4 so as to be developed. A toner image formed on the photosensitive drum is transferred onto a transfer belt of a primary transfer unit 2. In the case of full-color copying, toner of four colors (Bk, C, M, and Y) is successively overlaid onto the primary transfer belt to be subjected to color composition.

In the case of full-color copying, at the time of completion of the four-color image formation and the transfer process, transfer paper (print paper) is fed from a feeding unit 1 in synchronization with the primary transfer belt, and the toner image subjected to color composition on the primary transfer belt is transferred onto the transfer paper by a paper transfer unit 10. The feeding of the transfer paper to the paper transfer unit 10 is controlled in accordance with a print conditions attached to a print job. In other words, the image forming apparatus according to the present embodiment can perform printing onto different-sized transfer paper and printing onto both sides of transfer paper, and includes some units for performing the feeding operation of different-sized transfer paper and the reverse feeding operation of transfer paper on duplex printing in accordance with instructions from a controller of the data processing system (see FIG. 2), which will be described later. Because these units themselves can be embodied by employing existing units, the detailed description thereof will be omitted herein.

The transfer paper onto which the toner image has been transferred is sent to a fixing unit 7 through a transfer unit 11 and is subjected to thermal fixing by a heater-heated fixing roller and a pressing roller. The transfer paper is then discharged. The heater used herein employs a structure that can operate the heater partially in accordance with the size of the transfer paper, thereby reducing wasteful power consumption. For fixing control that performs heating operations in accordance with print conditions or the like, the details thereof will be described later.

Configuration of Data Processing System

FIG. 2 is a block diagram illustrating the schematic configuration of the data processing system of the image forming apparatus 100. In the image forming apparatus 100 according to the present embodiment, the inputting of image data when the copier's functions are used is performed by scanning a document by a scanner 61 (that corresponds to the scanning unit 5 in FIG. 1). The processing of the image data input from the scanner 61 is performed in accordance with a print job registered in accordance with the settings of an operation mode, print conditions, or the like from an operating unit 65 functioning as a user interface (I/F). The operating unit 65 is connected to the scanner 61 through an operating unit I/F 57 and a controller 50.

The inputting of print data when the printer's functions are used is performed through a network 200 together with the registration of print jobs. For this reason, the image forming apparatus 100 includes a network I/F 58 to be connected to the network 200. The controller 50 includes a processing unit that performs processing on the print data received through the network I/F 58. This processing unit analyzes the print data, generates draw data as print output data for use in output, and extracts print conditions to be set in a printer 62 or the like.

A CPU 51 within the controller 50 is hardware that constitutes a unit that controls the entire image forming apparatus 100. A random access memory (RAM) 53 is a memory used as a working memory that allows the CPU 51 to temporarily store intermediate processed data and control/processing programs for controlling input/output devices for data, such as images (including the network I/F 58), and various operating units. A read only memory (ROM) 52 is a memory used as a boot ROM that stores therein a boot program of the image forming apparatus 100.

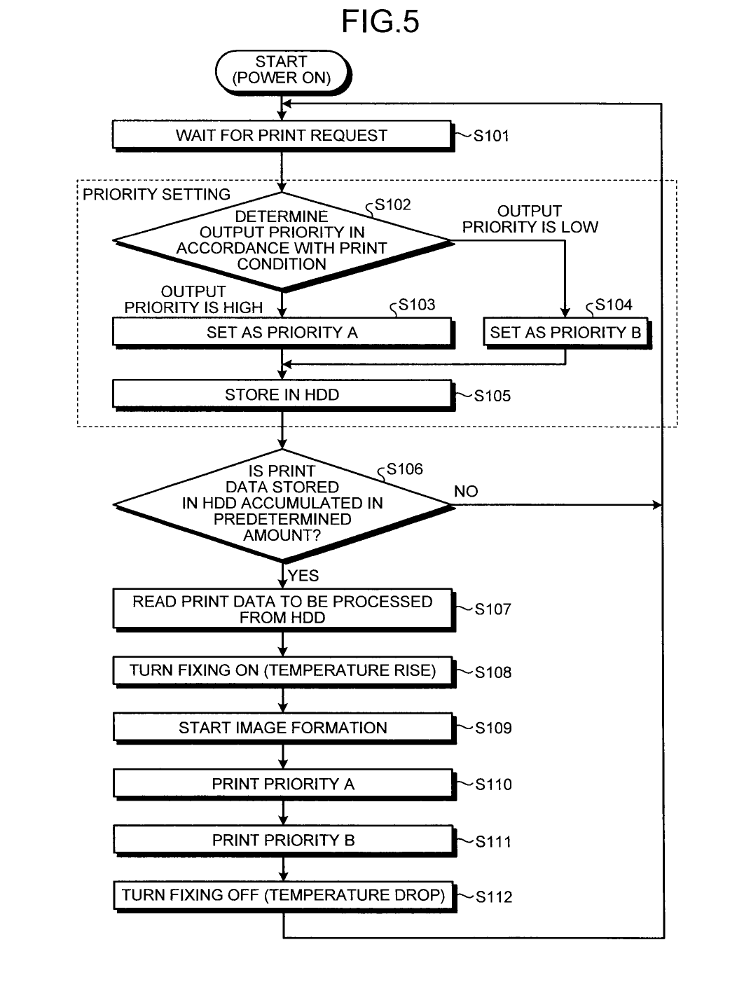

A non-volatile storage unit such as a hard disk drive (HDD) 56 or a non-volatile RAM (NV-RAM) 54 stores therein system software, image data, software counter values, and the like. By storing a program that executes the procedures in FIGS. 5 to 8 associated with print output operations, which will be described later, in the storage (recording) unit such as the HDD 56, the CPU 51 reads the control/processing program, control data, and the like into the RAM 53, and the program is executed during the execution of any processing, thereby allowing the CPU 51 (computer) to function as an executing unit for the processing.

A bus I/F 55 is a bus bridge connecting a system bus 48 and an image bus 49 that transfers image data at high speed and converting data structure. The image bus 49 connects an engine I/F 60 and a data processing unit 59.

The engine I/F 60 connects the scanner 61 or the printer 62 to the controller 50 and performs synchronous/asynchronous conversion on image data.

The data processing unit 59 performs correction and resolution conversion, and the rotation, compressing/expanding, processing, editing, and the like of image data on the image data input from the scanner 61 and the print data (draw data) input from the network 200 in accordance with set operation modes and processing conditions. These modes and conditions include apparatus-dependent conditions and ones directed by user's operations or ones directed by print data generated by a printer driver.

The controller 50 instructs a power controller (not illustrated) that supplies power to each circuit as well as the heater of the fixing unit 7, to be in a power-saving mode when in an idle state or not in use. This power saving mode corresponds to a power supply operation that, for example, when an idle state continues for a predetermined period of time, switches from a normal mode (a mode in which the apparatus can start an operation immediately upon reception of a print job or the like) to an operating state in a mode that power supply to any part other than any specific circuit for which power supply cannot be stopped is stopped or restricted (also referred to as a sleep mode).

The controller 50 controls power supply depending on the state of a job to be processed. For example, power supply to the heater of the fixing unit 7 (hereinafter, referred to as the fixing heater) depends on the state of the print job. Depending on the presence or absence of a print job, in other words, it is controlled so that a fixing temperature for fixing toner is maintained when the printer 62 is in use whereas a temperature on standby is maintained when it is not in use. Furthermore, the fixing temperature when it is in use is changed in accordance with the print condition specified in the print job, thereby allowing fixing processing to be performed with a minimal temperature.

As one of its unique operations, the image forming apparatus 100 according to the present embodiment performs, as will be described later, control so that an output order is set for a job group waiting for printing in accordance with print conditions specified in print jobs in the job group to minimize the amount of power for use in heating, and the fixing heater is operated in accordance with fixing temperatures set as target values for the respective jobs. When retuning from the power-saving mode or a standby mode to the normal mode or an operating mode when in use, the controller 50 instructs the return upon the occurrence of a predetermined condition such as the inputting of a job.

Print Output Operation

The print output operation by the image forming apparatus 100 according to the present embodiment will now be described in detail. When not in use, that is when there is no job waiting for printing, the printer 62 is in a standby state in which its operation is stopped, and the temperature of the fixing unit 7 is maintained at a set temperature on standby. Then, when a print job is received and a job group waiting for printing occurs, the controller 50 that manages print jobs performs a conventional procedure as a normal procedure in which the received jobs are successively subjected to print output in the order they are registered (in the order they are input). When the same print condition is specified in the print jobs in the job group waiting for printing and it is not required to change the settings of operating conditions related to thermal fixing such as a target fixing temperature value with power saving taken into account, in other words, when the same setting condition can be applied to the print jobs, the output of the print jobs are performed in the order they are registered in the image forming apparatus 100 according to the present embodiment in the same manner as the conventional case.

However, when the same print condition is not specified in the print jobs in the job group waiting for printing, and operating conditions related to heat fixing such as a target fixing temperature value with power saving taken into account and the like are different, the settings thereof are changed between the print jobs. In this case, if print output is performed in the order they are registered, for example, the target fixing temperature may change between the print jobs, thereby causing repetition of temperature rise from a lower temperature to a higher temperature. In such a case, the heat during the temperature rise period is not effectively used for fixing, and power usage efficiency degrades accordingly.

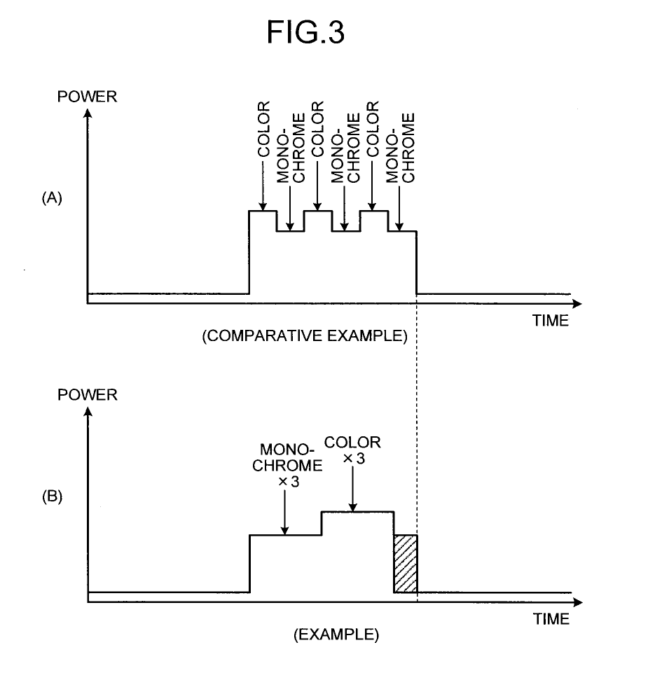

FIG. 3 illustrates a graph (A) showing the relationship of temporal changes in the drive power of a fixing heater with respect to time in a case (Comparative Example) in which output is performed for a job group waiting for printing in accordance with the conventional procedure. Graph (A) of FIG. 3 illustrates temporal changes in power that drives the fixing heater when the print output of a job group that alternately and successively outputs “color” and “monochrome” jobs, which are different in print color, as a print condition (color×3 and monochrome×3) is performed.

Because a color image requires a higher fixing temperature than a monochrome image does, the temperature is raised when printing is performed in the order of monochrome to color. In the example of graph (A) of FIG. 3, the temperature rises two times while the job group (color×3 and monochrome×3) is being processed. Because during this temperature rise period the fixing unit 7 does not perform fixing processing until it reaches a fixing temperature for the color image, heat is not effectively used, leading to decreased efficiency.

Given this situation, the temperature rise period, which cannot be utilized effectively, is reduced to the extent possible, thereby reducing wasteful power consumption and improving power usage efficiency. In other words, the output order of a job group waiting for printing is set to minimize power for use in a heating operation in accordance with print conditions specified in print jobs in the job group. In performing this setting, when the output order is already set in the order of registration, the setting is changed depending on print conditions.

FIG. 3 also illustrates a graph (B) showing the relationship of changes in the drive power of a fixing heater with respect to time in a case (Example) when the output order is set to minimize power for use in the heating operation. This operating example is performed for a job group with the same number of jobs as in graph (A) of FIG. 3 (color×3 and monochrome×3).

In graph (B) of FIG. 3, the temperature rise period, which cannot be utilized effectively, is limited to only one time. In other words, print output is collectively performed for each set of color and monochrome jobs, thereby reducing the temperature rise period, which cannot be utilized effectively, in a power consuming period and reducing the amount of power consumption by the fixing heater by the corresponding amount (the hatched part in graph (B) of FIG. 3).

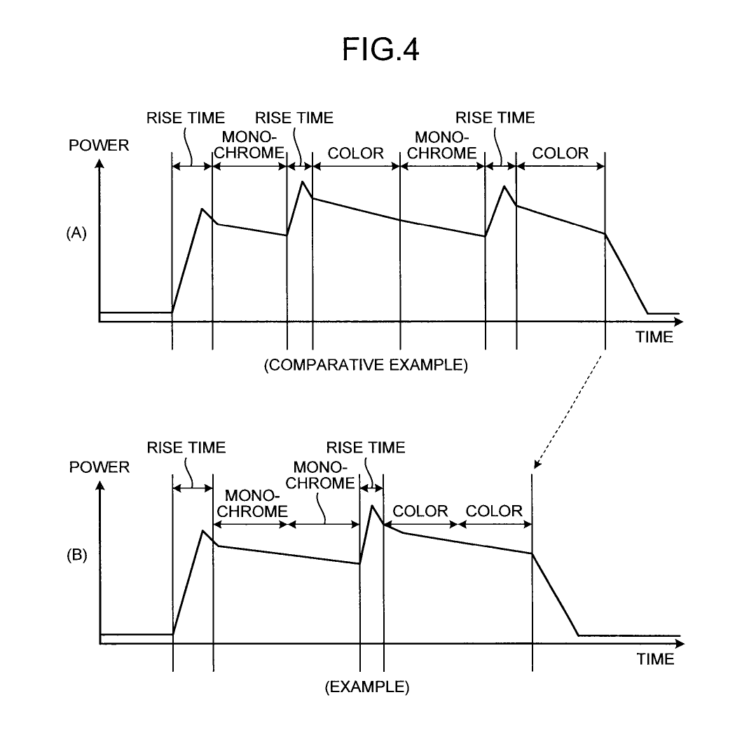

FIG. 4 illustrates graphs showing the relationship of temporal changes in the drive power of a fixing heater with respect to time similar to that of the above FIG. 3 in more detail with a rise time added. Graph (A) of FIG. 4 illustrates a case (Comparative Example) in which output is performed in accordance with the conventional procedure, whereas graph (B) of FIG. 4 illustrates a case (Example) in which the print output order is set to minimize the power for use in the heating operation.

In graph (B) of FIG. 4, in the initial standby state waiting for print output, a low-level constant voltage is applied, and when the print output of a print job group is started, the voltage is raised to a target fixing temperature value for monochrome output. Because of a rapid rise in this situation, the applied power also changes abruptly.

When the temperature is raised to the fixing temperature for monochrome output through the rise time, a sheet of paper is passed through the fixing unit 7, a fixing operation is started, and power for maintaining the fixing temperature is applied until the processing of a monochrome-output print job group (monochrome×3 in the example of graph (B) of FIG. 3) ends.

Next, for the output of a color-output print job group (color×3 in the example of graph (B) of FIG. 3), the temperature is raised to a target fixing temperature value for color output that is higher than that for monochrome output. During this rise time, because the temperature does not reach the fixing temperature for color output, fixing processing is not performed.

When the temperature is raised to the fixing temperature for color output through the rise time, power for maintaining the temperature is applied until the processing of the color-output print job group (color×3 in the example of graph (B) of FIG. 3) ends.

In graph (A) of FIG. 4, because monochrome output and color output are performed alternately, every time the monochrome output switches to the color output, the rise time occurs (two times in the example of graph (A) of FIG. 4).

As described above, in graph (B) of FIG. 4, the output order of the job group waiting for printing is set so that print output is collectively performed for each set of color and monochrome jobs, thereby reducing the temperature rise period, which cannot be utilized effectively, in a power consuming period (once in the example illustrated in graph (B) of FIG. 4) and reducing the integral power consumption as compared to graph (A) of FIG. 4.

In the output order illustrated in graph (B) of FIG. 4, a print job having a lower target fixing temperature value (monochrome output in the example of graph (B) of FIG. 4) is performed first after the starting up from the standby state waiting for print output. Thus, the print job having a lower fixing temperature is given a higher priority, thereby reducing the rise period from the standby state. The temperature rise period, which cannot be utilized effectively, is thus further reduced, thereby reducing wasteful power consumption and minimizing integral power for use in the heating for fixing.

Basic Operation Procedure

The following will describe a basic operation procedure when print output is performed in an output order that minimizes power for use in the fixing heater based on print conditions specified in print jobs in a print job group waiting for printing. One of the operating conditions of the fixing unit 7 that has an influence on the power consumption is a fixing temperature. The power consumption increases as the fixing temperature rises. Another condition is the structure of the fixing heater that is required to be changed in accordance with the size of paper to be heated, duplex printing, or the like. In other words, when a fixing heater for heating is added for large-sized paper, the power consumption of all of the fixing heaters increases.

Because these operating conditions of the fixing unit 7 are set in accordance with print conditions specified in print jobs, the magnitude relation of the power consumption for outputting the print jobs can be determined from the print conditions. If the magnitude relation of power consumption is determined from the print conditions, the output order that minimizes power for use in fixing for the job group waiting for printing, which was explained with reference to graph (B) of FIG. 4, can be determined from the print conditions specified in print jobs.

The procedure is as follows. Based on known power consumption corresponding to various print conditions specified in print jobs, an output priority is determined in advance for each print condition, thereby forming a print condition/output priority correspondence table that associates prescribed print conditions with output priorities. The formed table is stored in a storage unit under the control of the controller 50, for example, in the NV-RAM 54.

Before executing the printing of a job group waiting for printing, the controller 50 acquires output priorities corresponding to print conditions specified in print jobs to be output by referring to the stored print condition/output priority correspondence table. Based on the acquired output priorities, the output order of the print jobs in the job group to be printed out is executed is set.

The output order of the job group waiting for printing is set as described above, thereby performing a heating operation with minimum power for use in the fixing heater.

FIG. 5 is a flowchart illustrating the basic procedure of a print output operation executed in an output order set based on print conditions. The procedure of FIG. 5 is a basic procedure applied to a job group waiting for printing. This procedure is commonly used under any print condition when heating operations for a fixing heater that are performed in accordance with print conditions specified in print jobs are different from each other (the power consumption are different). When the image forming apparatus 100 is turned on and initialization is complete, the controller 50 starts the procedure of FIG. 5 and performs the operation following this procedure until being shut down.

After starting the procedure of FIG. 5 by turning on the apparatus, the controller 50 allows the fixing unit 7 to be in a standby state in order to reduce power consumption to a minimum until receiving a print request (print job) by the pressing of a print key of the operating unit 65 or the like (Step S101).

Then, upon receiving the print job, the controller 50 refers to the print condition/output priority correspondence table stored in the NV-RAM 54 or the like in advance and determines an output priority in accordance with the print condition specified in the print job for the received print job (Step S102). Based on the determination result, the controller 50 performs the setting of an output order that minimizes power for use in the fixing heater (Steps S103 and S104). The present procedure illustrates a procedure for a case in which output priorities in accordance with two types in a specific print condition, such as whether the print color is color or monochrome, are determined. For example, when the print condition specified in the print job is monochrome, its priority obtained by referring to the print condition/output priority correspondence table is higher than that of the print condition for color. The print job is therefore set as “Priority A,” which is ordered higher than color (Step S103). When the print condition is color, the print job is set as “Priority B,” which is ordered lower than monochrome (Step S104). Concerning the output order of the print jobs, the print job set as Priority A takes priority over the print job set as Priority B. Concerning print jobs set as the same priority, in other words, print jobs with the same output priority, the output order of the print jobs may be set in the order they are registered (input) for Priority A and Priority B.

Next, the set output order is stored in the HDD 56 in association with the print jobs (Step S105). In the present procedure, the procedure of the above Steps S102 to S105 are repeated until the print jobs are accumulated in a predetermined amount, thereby collecting the print jobs with respect to each output priority with Priority A (monochrome) to be output first. With this, printing is executed in an output order that minimizes power for use in fixing. The controller 50 then checks whether the print jobs stored in the HDD 56 have been accumulated in a predetermined amount (Step S106). If they have not been accumulated in a predetermined amount (No at Step S106), the procedure returns to Step S101 and waits for a print job.

If the print job (or print data) is accumulated in the HDD 56 in a predetermined amount (Yes at Step S106), the procedure advances to process of executing printing. The controller 50 then reads the print data of the print jobs, each set as Priority A or Priority B, from the HDD 56 together with information indicating the output order (Step S107). The controller 50 turns the fixing heater of the fixing unit 7 on to raise the temperature to a fixing temperature from the standby state (Step S108).

Next, the controller 50 starts the processing of the printer 62 that forms an image through the electrophotographic process (Step S109). The order of image forming processing follows the output order read at Step S107. In other words, processing (printing) on all the print jobs set as Priority A is executed first (Step S110), and after the completion of the processing of Priority A, processing (printing) on the print jobs set as Priority B is executed (Step S111). If all the print jobs set as Priority B have been executed at S111, the controller 50 drops the temperature of the fixing heater of the fixing unit 7 from the fixing temperature to the temperature in the standby state (Step S112) and the procedure returns to Step S101 again and waits for a print job.

Operation Procedure Corresponding to Various Types of Print Conditions

The above basic operation procedure describes a procedure to be applied to two types of print conditions having different power consumption. Procedures will be described herein that are applied to various types of print conditions including “print color,” “the material of print paper,” “print paper size,” and “the type of duplex or single-sided use of the paper.”

Because a fixing temperature varies depending on whether the print color is monochrome or color, the power consumption of the fixing heater varies. Furthermore, because a fixing temperature varies depending on whether the material of print paper is thick paper or normal paper, the power consumption of the fixing heater varies. Still furthermore, because the structure of the fixing heater varies depending on the print paper size, the power consumption of the fixing heater varies. Still furthermore, because the structure of the fixing heater varies depending on the type of duplex or single-sided use of the paper, the amount of power consumption of the fixing heater varies.

The power consumption of the fixing heater varies depending on the above types for print conditions of the print color, the material of print paper, the print paper size, and the type of duplex or single-sided use of the paper. In a print job specifying these conditions combined, the power consumption varies depending on the combination of these conditions. It is required also in this case to determine and set an output order that minimizes power for use in fixing, in other words, the output order of the print jobs in the ascending order of the power consumption. For this reason, based on known power consumption corresponding to the combined print conditions, output priorities with respect to the combination of the print conditions are set in advance. Basically, as is the case with the above basic operation procedure, a print condition/output priority correspondence table is formed and stored. When executing the printing of a job group waiting for printing, the controller 50 determines an output priority for each print job by referring to the print condition/output priority correspondence table, thereby setting the output order in accordance with the determination result.

The output order of the print jobs waiting for printing is set as described above, thereby performing the heating operation that minimizes power for use in the fixing heater in accordance with various print conditions.

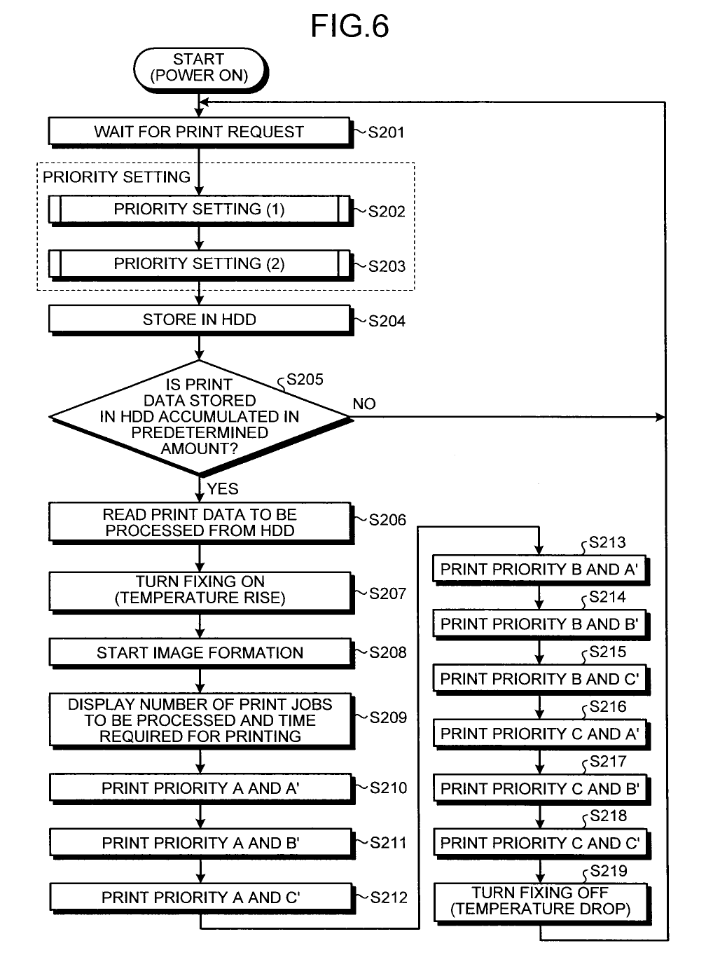

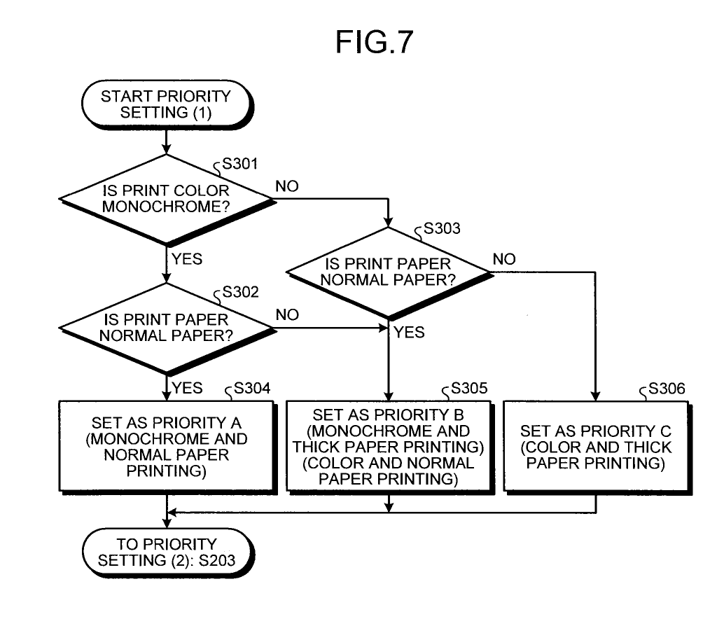

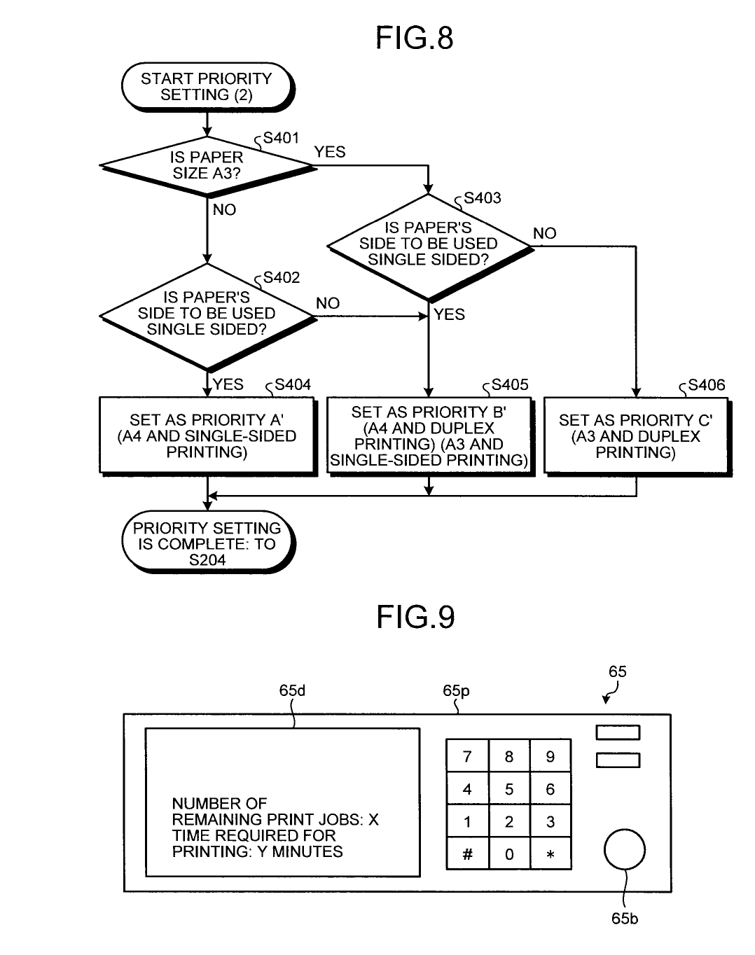

FIG. 6 is a flowchart illustrating the procedure of a print output operation in an output order set according to print conditions including print color, the material of print paper, print paper size, and the type of duplex or single-sided use of the paper. FIG. 7 is a flowchart illustrating the subroutine of priority setting (1) (Step S202) in FIG. 6, and FIG. 8 is a flowchart illustrating the subroutine of priority setting (2) (Step S203) in FIG. 6.

The procedure of FIG. 6 sets an output order with nine levels corresponding to the combinations of conditions obtained by dividing into two each of the four print conditions that are print color, the material of print paper, print paper size, and the type of duplex or single-sided use of the paper. This is an example in which the number of different combinations and the number of levels in the output order do not match. In this example, output is performed in an order that is set through two-step process. The first process includes a first setting step for setting priorities with three levels for print conditions of different fixing temperatures, and a second setting step for setting priorities with three levels for print conditions of different heater structures. The second process includes a setting step for finally setting an output order with nine levels based on the setting results set at the first and second setting steps.

When the image forming apparatus 100 is turned on and initialization is complete, the controller 50 starts the procedure of FIG. 6 and performs the operation following this procedure until being shut down.

After starting the procedure of FIG. 6 by turning on the apparatus, the controller 50 allows the fixing unit 7 to be in a standby state in order to reduce power consumption to a minimum until receiving a print request (print job) by the pressing of the print key of the operating unit 65 or the like (Step S201).

Then, upon receiving the print job, the controller 50 refers to the print condition/output priority correspondence table stored in the NV-RAM 54 or the like in advance and performs on the received print job the first and second setting steps for setting an output order in accordance with the print condition specified in the print job. The first and second setting steps are, in the present procedure, performed by respective subroutines.

In the first setting step (Priority Setting (1)) performed by the subroutine of FIG. 7, print conditions of combination of the type of print color (monochrome or color) and the type of material of print paper (thick paper or normal paper), which are print combinations of different fixing temperatures, are determined and, then, priorities are set according to the determination results.

Specifically, the controller 50 first determines which type of print color, monochrome or color, the print condition specified in the print job is (Step S301). If it is monochrome (Yes at Step S301), the controller 50 then determines which type of the material of print paper, thick paper or normal paper, the print condition is (Step S302). If the print condition determined at Step S302 is normal paper (Yes at Step S302), the controller 50 refers to the print condition/output priority correspondence table and obtains an output priority corresponding to the combination of “monochrome and normal paper.” Because the output priority corresponding to this combination is the highest in Priority Setting (1), this combination is set as “Priority A,” which is a high order (Step S304).

If the print condition determined at Step S302 is thick paper (No at Step S302), the controller 50 refers to the print condition/output priority correspondence table and obtains an output priority corresponding to the combination of “monochrome and thick paper.” Because the output priority corresponding to this combination is lower than the output priority corresponding to the combination of “monochrome and normal paper,” this combination is set as “Priority B,” which is ordered lower than “Priority A” (Step S305).

If the print condition determined at Step S301 is color (No at Step S301), the controller 50 then determines which type of material of print paper, thick paper or normal paper, the print condition is (Step S303). If the print condition determined at Step S303 is normal paper (Yes at Step S303), the controller 50 refers to the print condition/output priority correspondence table and obtains an output priority corresponding to the combination of “color and normal paper.” Because the output priority corresponding to this combination is the second highest in Priority Setting (1), this combination is set as “Priority B” (Step S305). In the present procedure, “color and normal paper” and “monochrome and thick paper” are set with the same priority.

If the print condition determined at Step S303 is thick paper (No at Step S303), the controller 50 refers to the print condition/output priority correspondence table and obtains an output priority corresponding to the combination of “color and thick paper.” Because the output priority corresponding to this combination is the lowest in Priority Setting (1), this combination is set as “Priority C” (Step S306). The output order of the print jobs determined in Priority Setting (1) is as follows: the print jobs set as Priority A, the print jobs set as Priority B, and the print jobs set as Priority C. For the print jobs set as the same priority, or the print jobs having the same output priority, the output order may be determined in the order they are registered (input) among those with Priority A, B, or C.

After the first setting step (Priority Setting (1)) performed by the subroutine of FIG. 7, the process advances to the second setting step (Priority Setting (2)) in the procedure of FIG. 6 (Step S203). This step is performed by the subroutine of FIG. 8. In Priority Setting (2) performed by the subroutine of FIG. 8, print conditions of the type of print paper size and the type of duplex or single-sided use of the paper, which are print conditions of different structures of the fixing heater, are determined. Priorities are set according to the determination results. In this example, the type of print paper size, A3 or other than A3, is determined on the premise of a change of constitutional condition that a heater is added when the print paper size is A3.

Specifically, the controller 50 first determines which type of print paper size, A3 or other than A3, the print condition specified in the print job is (Step S401). If it is other than A3 (No at Step S401), the controller 50 determines which type of duplex or single-sided use of the paper the print condition is (Step S402). If the print condition determined at Step S402 is single-sided (Yes at Step S402), the controller 50 refers to the print condition/output priority correspondence table and obtains an output priority corresponding to the combination of “A4 and single-sided use.” Because the output priority corresponding to this combination is the highest in Priority Setting (2), the combination is set as “Priority A′,” which is a high order (Step S404).

If the print condition determined at Step S402 is duplex (No at Step S402), the controller 50 refers to the print condition/output priority correspondence table and obtains an output priority corresponding to the combination of “A4 and duplex use.” Because the output priority corresponding to this combination is lower than the output priority corresponding to the combination of “A4 and single-sided use,” this combination is set as “Priority B′,” which is ordered lower than “Priority A′” (Step S405).

If the print condition determined at Step S401 is A3 (Yes at Step S401), the controller then determines which type of duplex or single-sided use of the paper the print condition is (Step S403). If the print condition determined at Step S403 is single-sided (Yes at Step S403), the controller 50 refers to the print condition/output priority correspondence table and obtains an output priority corresponding to the combination of “A3 and single-sided use.” Because the output priority corresponding to this combination is the second highest in Priority Setting (2), the combination is set as “Priority B′” (Step S405). In the present procedure, “A3 and single-sided use” and “A4 and duplex use” are set with the same priority.

If the print condition determined at Step S403 is duplex use (No at Step S403), the controller 50 refers to the print condition/output priority correspondence table and obtains an output priority corresponding to the combination of “A3 and duplex use.” Because the output priority corresponding to this combination is the lowest in Priority Setting (2), the combination is set as “Priority C′” (Step S406). The output order of the print jobs determined in Priority Setting (2) is as follows: the print jobs set as Priority A′, the print jobs set as Priority B′, and the print jobs set as Priority C′. For the print jobs set as the same priority, or the print jobs having the same output priority, the output order may be determined in the order they are registered (input) among those with Priority A′, B′, or C′.

After the second setting step (Priority Setting (2)) performed by the subroutine of FIG. 8, the process advances to Step S204 in the procedure of FIG. 6. In this step, the determined priorities are stored in the HDD 56 in association with the print jobs (Step S204). In the present procedure, the above Steps S202 to S204 are repeated until the print jobs are accumulated in a predetermined amount to thereby collect the print jobs for each priority, and an output order of the print jobs is set in accordance with the priority. With this, printing is executed in an output order that minimizes power for use in fixing. The controller 50 then checks whether the print jobs stored in the HDD 56 have been accumulated in a predetermined amount (Step S205). If they have not been accumulated in a predetermined amount (No at Step S205), the procedure returns to Step S201 and waits for a print job.

If the print job (or print data) is accumulated in the HDD 56 in a predetermined amount (Yes at Step S205), the procedure advances to the execution of printing. The controller 50 first reads the print data of the print jobs whose priorities were set in each of Priority Setting (1) and Priority Setting (2) from the HDD 56 together with information indicating the output order (Priority A, B, and C and Priority A′, B′ and C′) (Step S206). The controller 50 turns the fixing heater of the fixing unit 7 on to raise the temperature to a fixing temperature from the standby state (Step S207).

Next, the controller 50 causes the printer 62 to start image formation through the electrophotographic process (Step S208).

The controller 50, in accordance with the execution of printing, starts an operation that informs a user of the execution status of printing by the operating unit 65 (Step S209). This operation is performed to inform the user of the status of jobs that is not yet output and the time to complete printing, for example.

FIG. 9 is a diagram illustrating an example of a display screen displaying the processing status of print jobs in the operating unit 65. As illustrated in FIG. 9, an operating panel 65p of the operating unit 65 is provided with input units such as a print key 65b and a display unit 65d. The controller 50 allows the screen of the display unit 65d to display the number of remaining print jobs and the time required for printing, thereby informing the user of waiting time to complete printing. The number of remaining print jobs is retrieved from information on print jobs that are stored in the HDD 56 and wait for the execution of printing. The time required for printing is calculated based on the number of print jobs, print conditions, and processing performance obtained as an empirical value.

Image formation that starts at Step S208 is performed in an order based on the information indicating the output order (Priority A, B, and C and Priority A′, B′, and C′) read at Step S206. Because “Priority A, B, and C” is the result of Priority Setting (1) and “Priority A′, B′, and C′” is the result of Priority Setting (2), it is required that the output order has to be set for combinations of priorities obtained in Priority Setting (1) and Priority Setting (2). In this example, the output order of the combinations of “Priority A, B, and C” and “Priority A′, B′, and C′” is as follows. “Priority A and A′” (i.e., “monochrome and normal paper” and “A4 and single side”) is output with the first priority, followed by the output of “Priority A and B′,” “Priority A and C′,” “Priority B and A′,” “Priority B and B′,” “Priority B and C′,” “Priority C and A′,” “Priority C and B′,” and “Priority C and C′” (i.e., “color and thick paper” and “A3 and duplex”) in this order. For the output order corresponding to these combinations of “Priority A, B, and C” and “Priority A′, B′, and C′”, a table similar to the above print condition/output priority correspondence table may be formed in advance and used.

According to the output order of printing pursuant to the above priorities, processing (printing) for all the print jobs whose combination of priorities is “Priority A and A′” is executed first (Step S210). After the completion of the processing for “Priority A and A′,” processing (printing) for all the print jobs whose combination of priorities is “Priority A and B′” is then executed (Step S211). Then, in the above order of “Priority A and C′,” “Priority B and A′,” “Priority B and B′,” “Priority B and C′,” “Priority C and A′,” “Priority C and B′,” and “Priority C and C′”, processing (printing) for each print job is executed (Steps S212 to S218). If processing for all the print jobs is executed, the controller 50 drops the temperature of the fixing heater of the fixing unit 7 from the fixing temperature to the temperature in the standby state (Step S219). The procedure then returns to Step S101 again and waits for a print job.

As described above in detail with the specific examples, in the image forming apparatus 100 according to the present embodiment, a storage unit under the control of the controller 50, for example, the NV-RAM 54 stores therein the print condition/output priority correspondence table in which output priorities, which are set for different print conditions to reduce the power consumption of the fixing heater when the different heating operations are successively performed in accordance with different print conditions, are associated with their corresponding print conditions. The controller 50 refers to the print condition/output priority correspondence table stored in the NV-RAM 54 or the like to acquire the output priorities associated with the print conditions specified in the print jobs to be output. Based on the acquired output priorities, the output order of the print jobs to be output is set. The image forming apparatus 100 according to the present embodiment prevents power usage efficiency in the heat-fixing processing from decreasing and achieves further power saving.

The functions of the setting unit that set the output order of print jobs, which is the characteristic functions of the image forming apparatus 100 according to the present embodiment, are achieved by, for example, a computer program executed by the CPU 51 of the controller 50. The computer program for achieving the functions of the setting unit is, for example, stored in advance and provided in the HDD 56 or the like provided within the image forming apparatus 100. The computer program for achieving the functions of the setting unit may be stored and provided in a computer-readable medium such as a CD-ROM, a flexible disk (FD), a CD-R, and a digital versatile disc) as a file in an installable or executable format. The computer program for achieving the functions of the setting unit may be stored in a computer connected to a network such as the Internet and be provided by being downloaded through the network. The computer program for achieving the functions of the setting unit may be provided or distributed through a network such as the Internet.

Although the specific embodiment of the present invention has been described above, the present invention is not limited to the above embodiment as it is and can be embodied with various alterations added without departing from the essence thereof in a practical phase. In other words, the above configuration and operations of the image forming apparatus 100 are provided as specific examples, and various alterations may be added thereto in accordance with uses and purposes.

The present invention provides the effects of preventing a decrease in power usage efficiency in the heat-fixing processing and achieving further power saving.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a heating unit that uses electric power and performs a heating operation in accordance with a print condition specified in a print job to thermally fix a developer onto a recording medium;
a storage unit that stores therein output priorities, which are determined for different print conditions based on power consumption in a heating operation, so as to be associated with their corresponding print conditions; and
a setting unit that, in outputting a plurality of print jobs having different print conditions successively, sets an output order of the print jobs to be output in accordance with the output priorities.

2. The image forming apparatus according to claim 1, wherein
the heating unit performs the heating operation by controlling a fixing temperature for fixing the developer, and
the print conditions includes a condition under which a target fixing temperature value in controlling the fixing temperature is specified.

3. The image forming apparatus according to claim 2, wherein the print condition under which the target fixing temperature value is specified is a type of print color.

4. The image forming apparatus according to claim 2, wherein the print condition under which the target fixing temperature value is specified is a material of the recording medium.

5. The image forming apparatus according to claim 1, wherein
the heating unit performs different heating operations in accordance with a structural change of a heating element of the heating unit, and
the print condition includes a condition under which a structural change of the heating element is specified.

6. The image forming apparatus according to claim 5, wherein the print condition under which the structural change of the heating element is specified is the size of the recording medium onto which the developer is to be fixed.

7. The image forming apparatus according to claim 5, wherein the print condition under which the structural change of the heating element is specified is a type of single-sided or duplex use of the recording medium onto which the developer is to be fixed.

8. The image forming apparatus according to claim 1, further comprising an informing unit that informs a user of a status of a print job that is not yet output.

9. A computer program product comprising a non-transitory computer-readable medium containing a computer program that causes a computer to function as the setting unit of the image forming apparatus according to claim 1.

10. An output order setting method performed in an image forming apparatus including: a heating unit that uses electric power and performs a heating operation in accordance with a print condition specified in a print job to thermally fix a developer onto a recording medium; and a storage unit that stores therein output priorities, which are determined for different print conditions based on power consumption in a heating operation, so as to be associated with their corresponding print conditions,
the output order setting method comprising:
acquiring, in outputting a plurality of print jobs having different print conditions successively, output priorities associated with the print conditions specified in the print jobs to be output from the storage unit; and
setting output order of the print jobs to be output in accordance with the acquired output priorities.
